(19) United States
(12) Patent Application Publication
(10) Pub. No.: US 2005/0152585 A1
(43) Pub. Date: Jul. 14, 2005

(54) Print analysis

(76) Inventor: Will Shatford, Pasadena, CA (US)

Correspondence Address: Evelyn McConathy, Ph.D., J.D.;Drinker Biddle & Reath, LLP, One Logan Square, 18th and Cherry Streets, Philadelphia, PA, 19103-6996, US

(21) Appl. No.: 11/035,358

(22) Filed: Jan. 12, 2005

Related U.S. Application Data
(60) Provisional application No. 60/536,042, filed on Jan. 13, 2004.

(51) Int. Cl. G06K 9/00

(52) U.S. Cl. 382/124

(57) ABSTRACT

A method for print analysis comprising reading a first snapshot image from a plurality of snapshots from a subject print obtained using a print swipe sensor, storing the first snapshot in a memory, comparing the first snapshot against a template print, storing the results of the comparison, repeating the process for each of the snapshot images that comprise the plurality of images, and identifying a match between the subject print and said template print based on the stored results.

### RELATED APPLICATION

The present invention claims priority to U.S. Provisional Application No. 60/536,042, filed on Jan. 13, 2004, which is fully incorporated herein by reference.

### FIELD

The present invention relates generally to the field of fingerprint analysis, and, more specifically, to a process of fingerprint verification and/or identification.

### BACKGROUND

Fingerprints have been widely used for many years as a means for identification or verification of an individuals identity. For many years, experts in the field of fingerprints would manually compare sample fingerprints to determine if two prints matched each other, which allowed for identification or verification of the person that created the fingerprint. In more recent times, fingerprint recognition has been improved by using computer analysis techniques developed to compare a fingerprint with one or more stored sample fingerprints.

Computer analysis of fingerprints has typically involved comparing a complete fingerprint against one or more known samples. In applications where the objective is to identify an individual from a fingerprint sample, the subject fingerprint sample is typically compared to a large volume of samples taken from many people. The volume of samples are typically stored in a database, and the subject print is compared to each fingerprint in the database to determine if there exists a match between the subject sample and any of the samples in the database. For example, a fingerprint sample obtained at a crime scene might be compared to fingerprints in a database containing fingerprints of individuals with prior criminal histories in an attempt to identify the suspect. In applications where the objective is to verify an individual from a fingerprint sample, the subject fingerprint is typically compared to a smaller number of fingerprint samples. For example, fingerprint verification may be used to allow access to a restricted area. A persons fingerprint is sampled and compared against the fingerprints of those individuals who are permitted access to the restricted area. A match would indicate a verification of the individual's identity (i.e., that the individual providing the sample is in fact one of the individuals whose fingerprints are contained in the database) and access would be allowed.

In many identification and/or verification processes, a fingerprint pad is typically used to obtain the subject sample. A fingerprint pad is typically a small square sensor, usually one-half inch by one-half inch in size, upon which a person places his or her finger. A single image of the person's complete fingerprint is taken, normally using some form of camera or imaging device. The captured image is typically digitized and stored as a digital image that can be compared to other stored images of fingerprints.

More recently, swipe sensors have been developed to obtain fingerprint samples. A swipe sensor is typically a thin, rectangular shaped device measuring approximately one-half inch by one-sixteenth inch. The swipe sensor obtains a number of small images, or snapshots, as a finger is swiped past the sensor. A complete fingerprint image is obtaining by processing these snapshots to form a composite image. The compiling of the smaller images into a complete fingerprint is typically referred to as “stitching” the images.

Processing fingerprints in this manner (i.e., using a fingerprint pad having an imaging device or using a swipe sensor) requires extensive computing resources. Powerful microprocessors, significant amounts of memory, and a relatively long processing time are required to adequately process the fingerprints. A need exists for a method of processing fingerprints that is more efficient, i.e., uses less computer resources and less time. The present invention fulfils this need, among others.

### SUMMARY

A method for print analysis is provided comprising reading a first snapshot image from a plurality of snapshots from a subject print obtained using a print swipe sensor, storing the first snapshot in a memory, comparing the first snapshot against a template print, storing the results of the comparison, repeating the process for each of the snapshot images that comprise the plurality of images, and identifying a match between the subject print and said template print based on the stored results.

An exemplary embodiment includes using a basic matching process to perform a preliminary match between a snapshot and a template fingerprint. Additionally, a detailed matching process may also be employed to increase the reliability of the results.

Additional objects, advantages, and novel features of the invention will be set forth in part in the description, examples, and figures which follow, all of which are intended to be for illustrative purposes only, and not intended in any way to limit the invention, and in part will become apparent to the skilled in the art on examination of the following, or may be learned by practice of the invention.

### BRIEF DESCRIPTION OF THE DRAWINGS

For the purpose of illustrating the invention, there is shown in the drawings one exemplary implementation; however, it is understood that this invention is not limited to the precise arrangements and instrumentalities shown.

FIG. 1 illustrates an exemplary fingerprint imaging process using a fingerprint pad sensor.

FIG. 2 illustrates an exemplary fingerprint imaging process using a swipe sensor.

FIG. 3 is a flow chart illustrating the steps involved in practicing an exemplary implementation of the present invention.

FIG. 4 is a flow chart illustrating the steps involved in practicing a second exemplary implementation of the present invention

FIG. 5 illustrates a mapping technique that is employed in practicing an exemplary implementation of the present invention.

FIG. 6 illustrates minutia points contained within a fingerprint that are used for detailed matching in accordance with an exemplary implementation of the present invention.

FIG. 7 is a results table in accordance with an exemplary implementation of the present invention.

### DETAILED DESCRIPTION

Overview

Various types of systems have attempted to employ fingerprint verification in recent times. Increased security concerns present in today's world makes fingerprint verification a field of great interest. Applications using devices having limited memory and/or computing power (e.g., smart cards) would benefit greatly by being able to use fingerprint verification to reduce security concerns. However, current fingerprint processing methods are not conducive to use with such devices. A method of processing fingerprints that can quickly and accurately provide for fingerprint verification and that requires less computing resources is provided by the exemplary embodiment of the present invention. While the exemplary embodiment is discussed with reference solely to fingerprints, it should be noted that exemplary embodiment is applicable to all types of prints, including thumbprints, toe prints, palm prints, etc. Furthermore, it should be noted at this point that although the exemplary embodiment of the present invention shall be discussed with reference to fingerprint verification, alternate embodiments could also be used in conjunction with fingerprint identification.

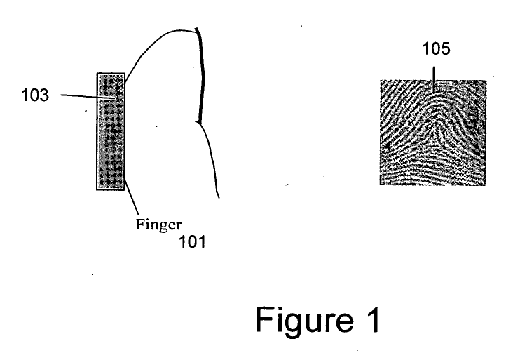

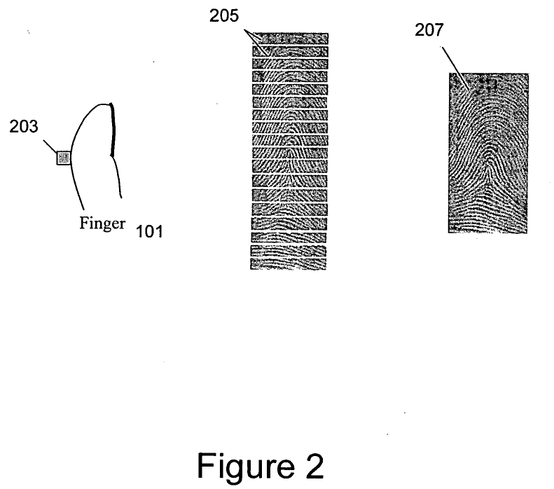

Current fingerprint verification techniques are typically applied to a complete fingerprint image. The image may be obtained using a fingerprint pad to generate the complete fingerprint image. Alternatively, a series of images may be generated using a swipe sensor. These images are then merged or “stitched” together to form a single complete fingerprint image that is suitable for use with existing verification techniques. Both techniques for obtaining the fingerprint image are memory intensive. For example, a typical commercially available pad sensor is shown in FIG. 1. The user places his or her finger 101 against the pad 103 and an image 105 of his or her fingerprint is taken. The image 105 typically contains 300 imaging rows. Each row contains 256 dots, with a resolution of 8 bits per dot. This results in 614,400 bits of data necessary to store a fingerprint image. A typical commercially available swipe sensor is shown in FIG. 2. A user passes his or her finger 101 along the swipe sensor 203 and a plurality of images 205 of his or her fingerprint are taken. Each image typically contains 8 imaging rows, each having 218 dots. The resolutions is 8 bits per dot, which results in a total of 13,952 bits of data necessary to store each snapshot.

While the resources required for each snapshot obtained using a swipe sensor, currently the snapshots need to be stitched together to form a single complete fingerprint image before fingerprint verification can be performed. A stitched image 207 can be over 600 rows of 218 dots. With each dot having a resolution of 8 bits, over one million bits of data are used to store a complete fingerprint image built by stitching snapshots obtained from a swipe sensor.

Fingerprint Processing Technique

In the exemplary embodiment of the present invention, fingerprint verification is performed on snapshot images from a swipe sensor without first using a stitching process to build a complete image. This allows for a significant reduction in computing resources required to perform the verification process. Because only a single snapshot from a swipe sensor is required to be stored at any given moment, the amount of storage memory is significantly reduced.

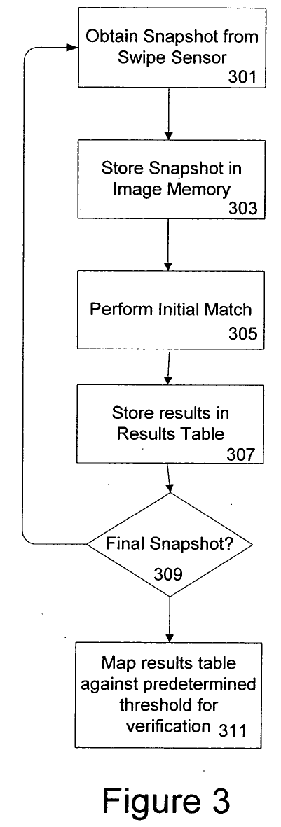

FIG. 3 is a flow chart illustrating the steps involved in a verification technique in accordance with an exemplary embodiment of the present invention is shown. A first snapshot of a fingerprint is obtained using a swipe sensor (step 301). The snapshot image is stored in memory. As set forth above, typical snapshot image from a commercially available swipe sensor requires approximately 13,952 bits of data. The data comprising the snapshot image is stored in an image memory (step 303).

Initially, a basic matching process is applied to the stored snapshot image (step 305). For example, the snapshot is compared against various segments, or zones, of a template fingerprint. A zone is defined as a section of the template fingerprint that is approximately the same dimension as a snapshot from the swipe sensor. In an exemplary embodiment, the template fingerprint is pre-selected from a fingerprint verification database in accordance with other criteria. For example, in order to gain access to a system (e.g., an ATM machine), a user might be required to both swipe his or her card and also verify his or her identity using his or her fingerprint. Upon swiping the card, the template fingerprint associated with the user's card would be retrieved from a database. When the user swipes his finger using the swipe sensor, the data obtained from the sensor would be compared only against the pre-selected template print. Alternative embodiments include comparing the snapshot image against a plurality of template fingerprints (e.g., in applications where other identifying device such as a card, key, or password is used); however, limiting the comparison of the snapshot to a single template would require less computing resources and less time.

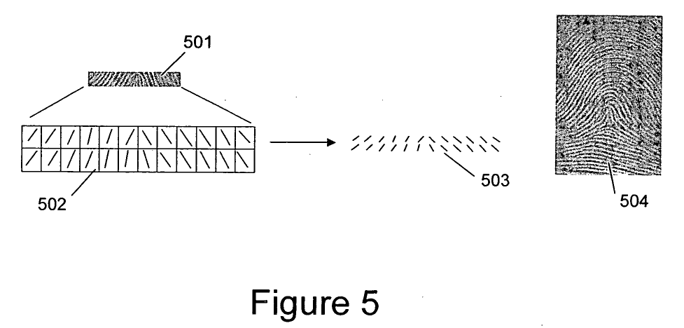

To perform the basic matching process, an orientation mapping process may be applied. Orientation mapping comprises reading an array of orientation markers indicating the direction of the fingerprint lines in the snapshot (i.e., the fingerprint is divided into a block grid, and the angle of each ridge line in each block is recorded, and then comparing the array to one or more zones within the template fingerprint. Referring to FIG. 5., an orientation map 502 of a snapshot 501 is obtained from the snapshot 501 and compared to orientation maps 503 from the template fingerprint 504. To simplify the matching process, the snapshot need not be matched against each zone since the likely area in which a match might occur is known. For example, if the snapshot image 501 is the first image from the swipe sensor, then the image need only be compared to the first few zones of the template print to check for a match. Because a user may not always start the scan with his or her finger in the same location relative to the swipe sensor, there can be some tolerance in the vertical direction. Typically, a user can position his or her finger in the same starting position to within ¼″ in the vertical direction. A scan that is not started in this position will not return a user verification. Because the exemplary embodiment requires the user to begin a scan within 1/4″ of the correct starting location, only zones within ¼″ of the expected location of the snapshot 501 need to be examined to determine if a match exists.

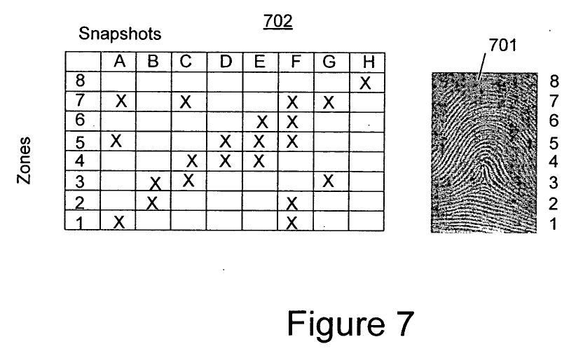

After the initial basic matching process is performed on the snapshot image, the results of the matching are stored in a table (step 307). An exemplary table of results is shown in FIG. 7, which is further described below. After storage of the results in the table, the image memory is cleared to provide memory to store the next snapshot image from the swipe sensor. A check is performed to determine if additional snapshots from the swipe remain (step 309). If additional snapshots remain, the next snapshot is obtained from the swipe sensor and the process is repeated.

If no additional snapshots remain, the results contained in the table are evaluated to determine if the criteria sufficient to obtain a fingerprint verification has been met (step 311). The threshold for a successful verification may be configured in several ways. For example, in the exemplary embodiment, the results are tabulated in a table 702 as shown in FIG. 7. FIG. 7 illustrates a fingerprint 701 that comprises 8 zones. Eight snapshots (listed A-H) are compared against the fingerprint 701. The results of each snapshot with respect to each zone is stored in the table 702. An “X” in the a particular zone indicates a level of orientation matching above a predetermined threshold. A pattern of “X” marks which form a rising line from left to right would indicate a match between the swiped fingerprint and the template fingerprint, as a matching print would have the initial snapshots match with the lower zones and subsequent snapshot match with subsequent zones throughout the template fingerprint. The level of matching required for verification can be selected depending on the level of security required in a particular application. For example, some applications may require a particular match criteria to be satisfied on a number of consecutive snapshots, while other applications may require a certain number of matched over the entire spectrum of snapshots. Should the particular level of matching necessary for verification not be reached before the swipe scan is completed, the user would not be verified.

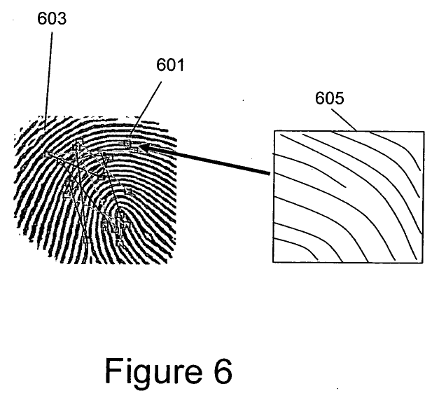

Some applications may require a still higher level of security than is provided using the basic matching technique described above. For applications that require higher security, a detailed matching process may be utilized in conjunction with the basic matching process described above. Detailed matching involves using fingerprint feature extraction, such as ridge spacing and minutia locations to improve the matching process. Minutia locations 603 with a fingerprint 601 are shown in FIG. 6. An exploded view of the minutia at a minutia location 603 is shown in block 605. Enhancement techniques, such as image filtering, line thinning, and line break filling can be applied to an image snapshot. These techniques are all well known to one of skill in the art.

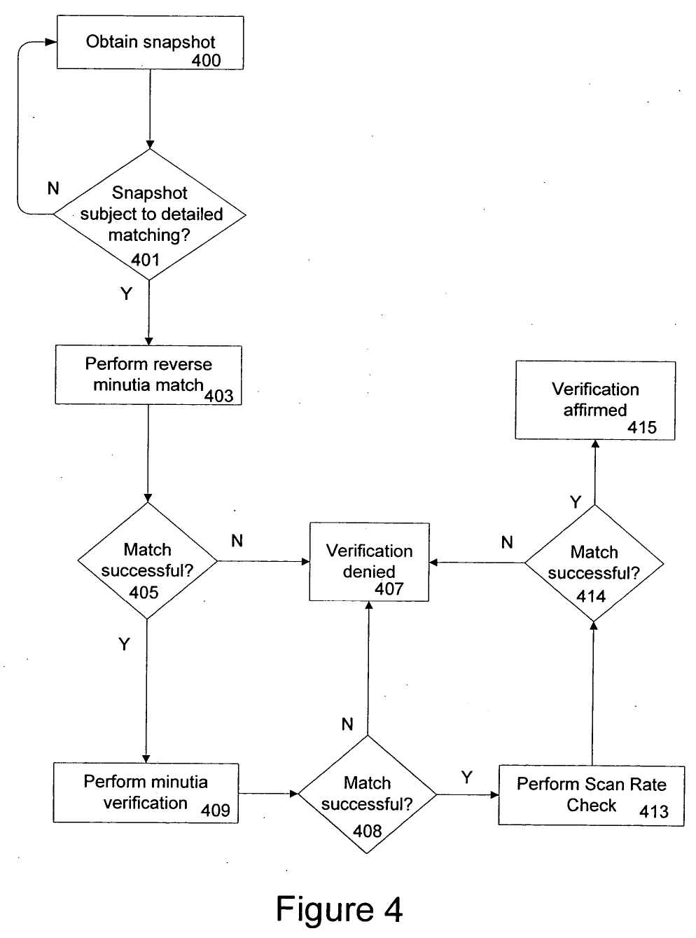

FIG. 4 is a flow chart illustrating the steps involved in an exemplary embodiment that incorporates detailed matching. In the exemplary embodiment, a snapshot is obtained in the manner described with respect to the basic matching (400). The snapshot is then checked to see if the snapshot should be subjected to the detailed matching process (401). Typically, the detailed matching process is not undertaken on the beginning snapshots. Only if the first few snapshots yield an expected result from the basic match process is the detailed matching process then applied to subsequent snapshots. This prevents unnecessary processing, which conserves computing resources. This can be especially important in applications where the system is employed on a battery-operated device, as limiting unnecessary processing will reduce power requirements.

If the snapshot is subject to detailed matching, a determination is made whether an expected endpoint in a template fingerprint matches an apparent endpoint in a particular snapshot. This process is referred to as a reverse minutia match (step 403). All fingerprint images contain endpoint minutia and, due to normal image quality, breaks in the lines in the image. Typically, image enhancement can be used to repair such breaks to recreate solid lines; however, enhancement does not normally create breaks. Thus, if an expected endpoint in the template fingerprint coincides with a solid line in the snapshot, there is likely not a match. A determination is therefore made at this point of whether the match is successful (step 405). Processing is terminated (i.e., no additional enhancement is undertaken) and verification is denied if a match is not found (step 407).

If a snapshot passes the reverse minutia match process, the snapshot image is further enhanced for a second detailed match process. A minutia verification process is performed on the snapshot (step 409). This involves confirming that the minutia in the snapshot are not merely caused by a line break by using an image enhancement process. If the minutia determinations are found to be accurate and a match is made with the template (408), verification may be confirmed at this point.

Alternatively, additional detailed processing may be performed. Embodiments of the invention can also include a measurement of scan rate. Scan rate is the speed at which a user passes his or her fingerprint in front of the swipe sensor. When the initial verification template is obtained, the scan rate can be recorded. As the scan rate is often consistent for a particular user between scans, scan rate can provide additional security. For example, fingerprint verification systems are subject to individuals who attempt to use phony fingerprints to fool the system. A system tricking technique that exists is known as using “Gummy bear” prints. In such cases, an individual obtains a fingerprint of an authorized user and makes a copy of it on something that can be placed over his or her own finger, such as a latex glove. The individual then passes the finger with the false print covering on it by the swipe sensor in an effort to fool the sensor into an incorrect verification. Scan rate can be used to cut down on false verifications, since the individual with the false print likely has a different rate at which he or she moves the fingerprint past the sensor.

The scan rate of a snapshot is measured and compared to the stored rate of the template print (413). If the rate falls within a predetermined tolerance, the match of the scan rate is deemed to be successful (414) and verification is affirmed (step 415). If not, verification is denied (step 407).

The exemplary embodiment of the present invention allows for verification processing to be performed on individual snapshots obtained using a swipe sensor. By employing these methods, the resources required for fingerprint verification are reduced. A variety of modifications to the embodiments described will be apparent to those skilled in the art from the disclosure provided herein. Thus, the present invention may be embodied in other specific forms without departing from the spirit or essential attributes thereof and, accordingly, reference should be made to the appended claims, rather than to the foregoing specification, as indicating the scope of the invention.

1. A method for print analysis comprising:
obtaining a snapshot image from a plurality of snapshot images of a subject print using a print swipe sensor;
placing said snapshot in a memory;
comparing said snapshot against a template print;
storing the results of said comparing step;
repeating said obtaining, placing, storing, comparing steps for each snapshot image of said plurality of snapshot images; and
identifying a match between said subject print and said template print based upon said results.

2. The method as set forth in claim 1, wherein the comparing set comprising:
performing a basic matching process; and
storing the results of said process in a table.

3. The method as set forth in claim 2, wherein said basic matching process is orientation mapping.

4. The method as set forth in claim 2, wherein the comparing step further comprises:
performing a detailed matching process subsequent to said basic matching process.

5. The method as set forth in claim 4, wherein said detailed matching process comprises a reverse minutia matching process.

6. The method as set forth in claim 4, wherein said detailed matching process comprises a minutia verification process.

7. The method as set forth in claim 2, wherein the comparing step further comprises:
measuring a scan rate of said snapshot; and
comparing said scan rate of said snapshot to a stored scan rate of said template.

8. The method as set forth in claim 1, wherein said print analysis method is used for print verification.

9. The method as set forth in claim 1, wherein said fingerprint analysis method is used for print identification.

10. A system for print analysis comprising:
means for obtaining a snapshot image from a plurality of snapshot images of a subject print using a print swipe sensor;
means for placing said snapshot in a memory;
means for comparing said snapshot against a template fingerprint;
means for storing the results of said comparing step;
means for repeating said obtaining, placing, storing, comparing steps for each snapshot image of said plurality of snapshot images; and
means for identifying a match between said subject print and said template print based upon said results.

11. A computer program product comprising a computer useable medium having program logic stored thereon, wherein said program logic comprises machine readable code executable by a computer, wherein said machine readable code comprises instructions for:
obtaining a snapshot image from a plurality of snapshot images of a subject print using a print swipe sensor;
placing said snapshot in a memory;
comparing said snapshot against a template print; and
storing the results of said comparing step;
repeating said obtaining, placing, storing, comparing steps for each snapshot image of said plurality of snapshot images,
identifying a match between said subject print and said template print based upon said results.

12. The computer program product as set forth in claim 11, wherein the instructions for comparing comprise instructions for:
performing a basic matching process; and
storing the results of said process in a table.

13. The computer program product as set forth in claim 12, wherein said basic matching process is orientation mapping.

14. The computer program product as set forth in claim 12, wherein the instructions for the comparing step further comprises instructions for:
performing a detailed matching process subsequent to said basic matching process.

15. The computer program product as set forth in claim 12, wherein said detailed matching process comprises a reverse minutia matching process.

16. The computer program product as set forth in claim 14, wherein said detailed matching process comprises a minutia verification process.

17. The computer program product as set forth in claim 14, wherein the instructions for the comparing step further comprise instructions for:
measuring a scan rate of said snapshot; and
comparing said scan rate of said snapshot to a stored scan rate of said template.

18. The computer program product as set forth in claim 13, wherein said print analysis method is used for print verification.

19. The computer program product as set forth in claim 13, wherein said print analysis method is used for print identification.
